(19) United States
(12) Patent Application Publication
(10) Pub. No.: US 2002/0067405 A1
(43) Pub. Date: Jun. 6, 2002

(54) Internet-enabled portable audio/video teleconferencing method and apparatus

(76) Inventor: James Michael McDiarmid, North Vancouver (CA)

Correspondence Address: FINNEGAN, HENDERSON, FARABOW, GARRETT &, DUNNER LLP, 1300 I STREET, NW, WASHINGTON, DC, 20005, US

(21) Appl. No.: 09/727,587

(22) Filed: Dec. 4, 2000

(51) Int. Cl. H04N 7/14; H04L 12/66

(52) U.S. Cl. 348/14.08; 348/14.01; 370/354

(57) ABSTRACT

A local computer having an IP communications link to the Internet runs Internet telephony application software. A microphone and a speaker are provided at a location removed from but within a reasonably short distance the computer. A first signal representative of voice sounds detected by the microphone is transmitted to the computer over a short range wireless link. The computer's Internet telephony software processes the first signal and further transmits it over the IP link to a remote computer. A second signal representative of remote sounds produced at the remote computer is received by the local computer from the remote computer over the IP link. The local computer's Internet telephony software processes the second signal and further transmits the processed second signal over the wireless link, for reproduction of the remote sounds by the speaker. Optionally, a camera and a video display may be provided at the location removed from the local computer. A third signal representative of images captured by the camera is transmitted to the local computer over the wireless link. The local computer's Internet telephony software processes the third signal and further transmits it over the IP link to the remote computer. A fourth signal representative of remote images captured at the remote computer is received by the local computer from the remote computer over the IP link. The local computer's Internet telephony software processes the fourth signal and further transmits the processed fourth signal over the wireless link, for reproduction of the remote images on the video display. Command and control application software can be run on the local computer. Before the first signal is passed to the Internet telephony software it is processed by the command and control software to determine if it contains a voice command. If so, the first signal is processed by the command and control software to perform the command to control operation of the local computer.

### TECHNICAL FIELD

This application pertains to usage of the Internet to facilitate extended duration audio and/or video teleconferencing type communications between two or more individuals in different locations.

### BACKGROUND

Internet protocol (IP) based communication technologies have made so-called “Internet telephony” possible. Briefly, Internet telephony enables two or more persons in different locations to conduct voice communications with one another at relatively low cost, irrespective of geographic distance between such persons and irrespective of the duration of such communications. By routing such communications over the Internet in a manner which largely or entirely bypasses the tariff mechanisms to which public switched telephone networks are subject, Internet telephony can reduce the cost of such communications to the cost of maintaining a computer-based Internet connection via an Internet service provider. Many Internet service providers now make “always on” Internet connectivity available to subscribers via cable modems and/or digital subscriber loop (DSL) technology for a flat monthly fee. Internet telephony enables a computer user having a flat fee based always-on Internet connection to conduct voice communications of theoretically unlimited duration with persons anywhere in the world, assuming such persons also have Internet telephony enabled computer-based Internet connections.

A shortcoming of currently available Internet telephony systems is the need for the user to remain closely proximate to a high quality microphone so that the user's speech can be reliably detected and transduced by the microphone. Conventionally, Internet telephony systems employ high quality microphones which are wired directly to the user's computer on which the Internet telephony enabling software runs. The length of the wire connecting the microphone to the computer (typically several feet) determines the region in which the user must remain while speaking during an Internet telephony session. It would be much more convenient if the user were not constrained to remain within such a small region during an Internet telephony session. Freedom from such constraint would permit the user to freely roam about a house, office or other location throughout the duration of an Internet telephony session, thus enhancing the user's experience by permitting the user to perform additional tasks during the Internet telephony session and enabling the user to take full advantage of always-on Internet connectivity to conduct Internet telephony sessions of extended duration (i.e. many hours). The present invention facilitates these improvements and also provides an Internet telephony based video conferencing capability.

### SUMMARY OF INVENTION

In accordance with the invention, a local computer having an IP communications link to the Internet runs Internet telephony application software. A microphone and a speaker are provided at a location removed from but within a reasonably short distance from the local computer. A first signal representative of voice sounds detected by the microphone is transmitted from the microphone to the local computer over a short range wireless link. The computer's Internet telephony application software processes the first signal and further transmits it over the IP communications link to a remote computer. A second signal representative of remote sounds produced at the remote computer is received by the local computer from the remote computer over the IP communications link. The local computer's Internet telephony application software processes the second signal and further transmits the processed second signal over the short range wireless link, for reproduction of the remote sounds by the speaker.

Optionally, a camera and a video display may also be provided at the location removed from the local computer. A third signal representative of images captured by the camera is transmitted from the camera to the local computer over the short range wireless link. The local computer's Internet telephony application software processes the third signal and further transmits it over the IP communications link to the remote computer. A fourth signal representative of remote images captured at the remote computer is received by the local computer from the remote computer over the IP communications link. The local computer's Internet telephony application software processes the fourth signal and further transmits the processed fourth signal over the short range wireless link, for reproduction of the remote images on the video display.

As a further option, command and control application software can be run on the local computer. Before the first signal can be passed to the Internet telephony application software for processing, the first signal is processed by the command and control application software to determine whether the first signal contains one or more voice commands. If the first signal contains one or more voice commands, the first signal is processed by the command and control application software to remove the command(s) from the first signal and perform the command(s) to control operation of the local computer.

### BRIEF DESCRIPTION OF DRAWINGS

FIG. 1 is a block diagram representation of an Internet-enabled, wireless, speakerphone and video conferencing system embodying the invention.

FIG. 2 is a block diagram illustrating components of one end node of the FIG. 1 system, including a portable wireless communication module.

FIG. 3 is a flowchart depicting the operation of software for controlling operation of a computer receiving signals from a portable wireless communication module and transmitting signals to the Internet, in accordance with the invention.

FIG. 4 is a flowchart depicting the operation of software for controlling operation of a computer receiving signals from the Internet and transmitting signals to a portable wireless communication module, in accordance with the invention.

FIG. 5 is a flowchart depicting the operation of software for controlling operation of a portable wireless communication module receiving signals from a computer, in accordance with the invention.

FIG. 6 is a flowchart depicting the operation of software for controlling operation of a portable wireless communication module transmitting signals to a computer, in accordance with the invention.

### DESCRIPTION

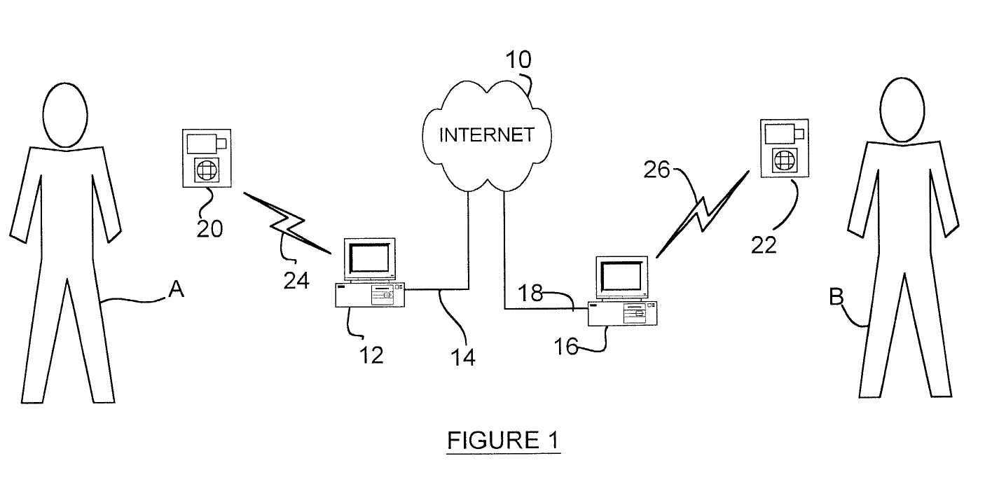

FIG. 1 depicts the Internet global communications network as a cloud 10, as is conventional. Two users “A” and “B” are depicted, it being understood that users “A” and “B” may each be in separate locations anywhere on the earth at which computer-based Internet connectivity is available. User “A” has a local computer 12 which is connected to the Internet 10 in conventional fashion via IP communications link 14 and user A's Internet service provider (not shown). Remote user “B” has a separate “remote” computer 16 which is similarly connected to the Internet 10 in conventional fashion via another IP communications link 18 and user B's Internet service provider (not shown).

In accordance with the invention, user “A” is provided with a wireless communications module 20 which may take any one of several different forms, as hereinafter explained. Module 20 enables user “A” to communicate with local computer 12 via short range wireless communication link 24, as hereinafter explained. Remote user “B” is provided with another wireless communications module 22, identical to module 20. Module 22 enables user “B” to communicate with remote computer 16 via short range wireless communication link 26, as hereinafter explained. It is not necessary for each of users “A” and “B” to be equipped with respective modules 20, 22 and wireless links 24, 26. Rather, a single user may attain the benefits of the invention if that user is equipped with a wireless communications module and wireless communication link as hereinafter explained, regardless of whether the remote user(s) with whom the so-equipped user communicates also have wireless communications module(s) and wireless communication link(s).

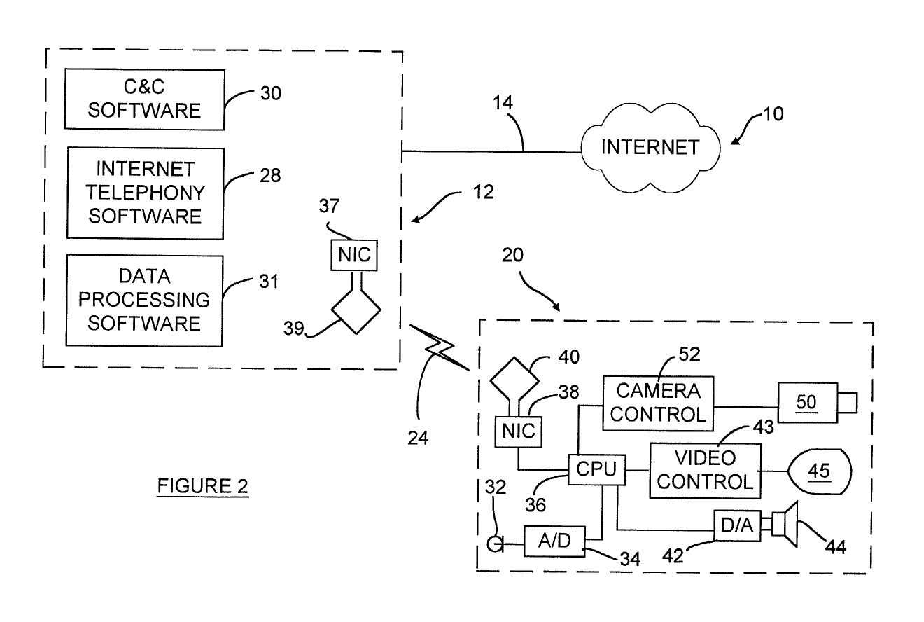

FIG. 2 provides further details of the invention. Since each user's computer, Internet connection, wireless communication module and wireless communication link can be identical to the computer, Internet connection, wireless communication module and wireless communication link of any other user, FIG. 2 depicts only user A's local computer 12, Internet connection 14, wireless communication module 20 and wireless communication link 24; and, the following discussion deals only with user A.

Local computer 12 is provided with and runs suitable Internet telephony application software 28 such as Microsoft® NetMeeting™, suitable command and control application software 30 IBM® ViaVoice™, and data processing software module 31. Internet telephony software 28 facilitates Internet telephone audio and/or video conferencing communications over the Internet with remote computer users, in conventional fashion. Command and control software 30 receives voice commands as hereinafter explained and controls the operation of local computer 12, again in conventional fashion. Data processing software module 31 pre-filters incoming data and distributes the data to either Internet telephony software 28 or command and control application software 30, as hereinafter explained. Local computer 12 is also provided with a network interface (NIC) 37 and a transmit-receive antenna 39. Wireless communication module 20 incorporates microphone 32, analog-to-digital (A/D) converter 34, processor (CPU) 36, network interface (NIC) 38, transmit-receive antenna 40, digital-to-analog (D/A) converter 42, speaker 44, video controller 43, video display 45 (which may be a light weight portable display such as that provided in the SONY® PLM-A35 GLASSTRON® personal theatre system) and a suitable power supply battery (not shown). Optionally, module 20 may also incorporate miniature video camera 50 and camera controller 52

The battery is electrically coupled to and provides electrical power for the aforementioned components incorporated in wireless communication module 20. NICs 37, 38 provide unique identifiers for local computer 12 and wireless communication module 20 respectively, enabling each of them to be uniquely identified and distinguished from other computers and/or peripherals (possibly including other wireless communication modules) with which local computer 12 communicates. Wireless communication between local computer 12 and its associated wireless communication module(s) can be based on a conventionally available wireless communication system such as a system constructed in accordance with the either of the Bluetooth™ or homeRF™ standards.

Wireless signals transmitted by local computer 12 via antenna 39 over wireless communications link 24 are received by module 20's antenna 40 and coupled to NIC 38, which decodes the signals and determines whether they are encoded with module 20's unique identifier. Received signals which are not encoded with module 20's unique identifier are ignored. Received signals encoded with module 20's unique identifier are passed by NIC 38 to CPU 36. The signals received by antenna 40 via link 24 may also include speech sound signals and/or video signals coded in accordance with a suitable compression algorithm by the Internet telephony software operating on a remote computer.

More particularly, if a remote user located at a remote computer speaks and/or utilizes a camera coupled to the remote computer while Internet telephony software runs on the remote computer, the software digitizes and compresses the remote user's speech sounds and/or the camera's video output signal and transmits to local computer 12 an IP packet stream representative of the digitized, compressed sound and/or video signals. Internet telephony software 28 running on local computer 12 receives the IP packet stream, extracts the digitized, compressed sound and/or video signals therefrom, and decompresses the signals. This yields an expanded, digitized replica of the remote user's speech sounds, and/or the remote camera's video output signal, which local computer 12 reformats in accordance with the wireless transmission protocol selected for communications over link 24 and then transmits, together with module 20's unique identifier, via antenna 39 and wireless communication link 24.

Antenna 40 detects the transmitted signal and couples it to NIC 38 as aforesaid. If the transmitted signal incorporates module 20's unique identifier then NIC 38 passes the signal to CPU 36 which applies the audio portion of the received, digitized signal to D/A converter 42. The digitized audio signal is converted to analog form by D/A converter 42 and then applied to speaker 44 which emits the remote user's speech sounds at a volume suitable for listening in the vicinity of speaker 44. The video portion (if any) of the received digitized signal is applied by CPU 36 to video controller 43 which processes the video signal in conventional fashion and applies the processed signal to video display 45 on which images captured by the remote user's camera appear.

Wireless module 20 is also able to transmit speech sounds and/or video signals from user A to local computer 12 and thence, via the Internet 10, to a remote computer and user. In particular, speech sounds produced by user A in the vicinity of module 20 are detected, transduced and applied by microphone 32 to A/D converter 34, which converts the signals into a digitized form suitable for transmission by CPU 36 to NIC 38. After encoding the signals with local computer 12's unique identifier, NIC 38 couples the signals to antenna 40 which transmits the signals to local computer 12 via short range wireless communications link 24. Video images captured by user A with camera 50 are processed by camera controller 52 into a format suitable for handling by CPU 36 and NIC 38. After encoding the video signals output by controller 52 with local computer 12's unique identifier, NIC 38 couples the signals to antenna 40 which transmits the signals to local computer 12 via wireless link 24. Local computer 12 and wireless communication module 20 may each be at separate locations, subject only to the need to ensure reliable receipt and transmission of wireless signals over link 24 between local computer 12 and module 20. For example, local computer 12 and module 20 may be at different locations within a reasonably sized office or residential building.

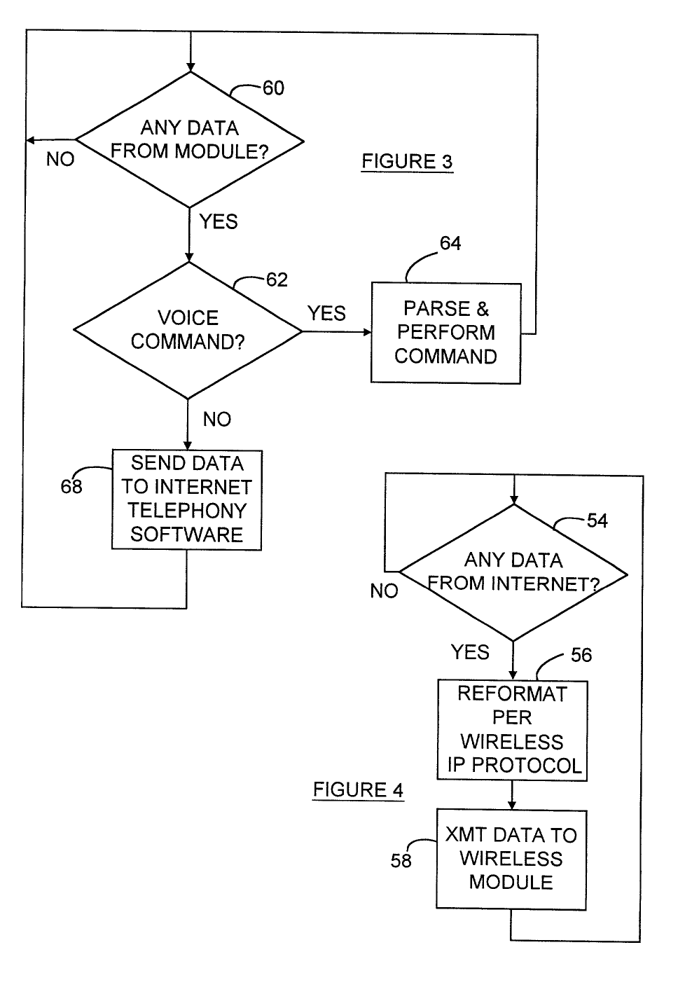

Signals received by local computer 12 from module 20 over wireless communications link 24 are first processed by software module 31, as shown in FIG. 3. Specifically, module 31 monitors (block 60) NIC 37 to determine whether any data has been received from module 20. If such data is received, a test (block 62) is performed to determine whether the received data signals contain one or more voice commands spoken by user “A”. If the block 62 test result is positive then the command-representative received data signal is passed to command and control software 30 which actuates local computer 12 to parse and perform (block 64) the command. If the block 62 test result is negative, then the non-command-representative received signal is passed (block 68) to Internet telephony software 28 which encodes, compresses and packetizes the received signal for IP transmission to a remote computer and user via the Internet 10.

Signals received by local computer 12 from the Internet 10 for transmission to wireless module 20 are processed by software module 31 as shown in FIG. 4. Specifically, module 31 monitors (block 54) IP communications link 14 to determine whether any data has been received from the Internet 10 for transmission to wireless module 20. If such data is received, the data is reformatted (block 56) in accordance with the wireless transmission protocol selected for communications over link 24 and then transmitted to module 20 via link NIC 37, antenna 39 and wireless communication link 24.

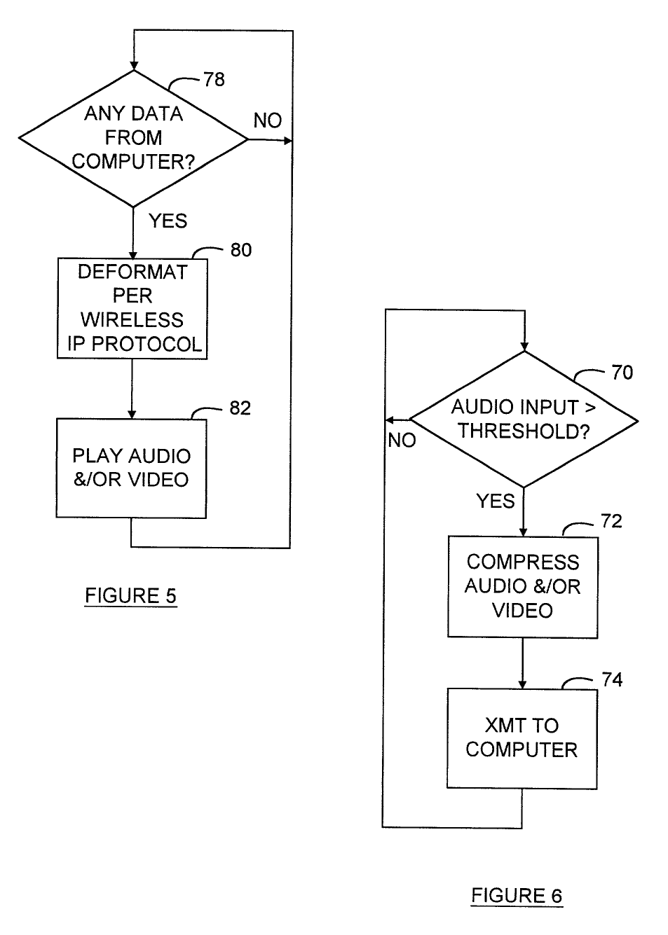

Signals received by wireless module 20 over wireless communications link 24 are processed by CPU 36 as shown in FIG. 5. Specifically, CPU 36 monitors (block 78) NIC 38 to determine whether any data has been received from local computer 12. If such data is received, the data is deformatted (block 80, i.e. to reverse the aforementioned FIG. 4, block 56 formatting). The audio portion of the deformatted data signal is then passed (block 82) to D/A converter 42 for application to speaker 44, and the video portion (if any) of the deformatted signal is applied to video controller 43 for reproduction on display 45.

Signals to be transmitted by wireless module 20 over wireless communications link 24 to local computer 12 are processed by CPU 36 as shown in FIG. 6. Specifically, CPU 36 monitors (block 70) audio signals received from microphone 32 via A/D converter 34 to determine whether such signals exceed a predefined background noise abatement threshold. If such signals exceed the threshold then they are reformatted (block 72) in accordance with the wireless transmission protocol selected for communications over link 24 and then passed (block 74) to NIC 38 for transmission to local computer 12 via link antenna 40 and wireless communication link 24. CPU 36 also accepts video signals received via controller 52 from camera 50, reformats the signals (block 72) in accordance with the wireless transmission protocol selected for communications over link 24 and passes the reformatted signals (block 74) to NIC 38 for transmission to local computer 12 via link antenna 40 and wireless communication link 24.

Wireless module 20 may take any one of several different forms. For example, microphone 32 may be a lapel microphone which can be clipped to the lapel area of user A's clothing and connected via a small wire to the remaining components incorporated in module 20, which can be contained within a small package suitable for mounting on user A's belt, insertion within a pocket provided in user A's clothing, etc. This embodiment enables user A to roam freely about a house, office, etc. within the range permitted by wireless communication link 24 while remaining in uninterrupted Internet telephony communication with one or more remote users. A possible disadvantage of this embodiment is that other persons in the same location as user A may be unable to conveniently participate in Internet telephony conversations with the remote user(s) since such other persons may have to stand uncomfortably close to user A, while user A is wearing microphone 32. However, this disadvantage may be largely offset by the aforementioned free roaming capability, the commercial availability of lapel type microphones which are largely immune to background noise (such as the Shure® SM93 omnidirectional subminiature lavalier condenser microphone), and the fact that user A may conduct relatively private communications by moving away from other persons while wearing or carrying module 20.

Alternatively, the module 20 components, including microphone 32 and camera 50, may be incorporated into a portable unit having a size and shape similar to that of a cellular telephone. User A could speak directly into microphone 32 while manoeuvring such a unit to capture images via camera 50 and while and roaming within the range permitted by wireless communication link 24; or, could place the unit on a convenient support surface and continue to carry out an Internet telephony based audio/video communication session. If desired, user A could pick up the unit and move it to a different location at any point in time during the communication session. By integrating microphone 32 with such a unit, this embodiment enables other persons in the same location as user A to more conveniently participate in Internet telephony communications with the remote user(s); since such other persons need not stand uncomfortably close to user A for their speech to be detected by microphone 32 and/or for their images to be captured by camera 50. For example, the unit could be placed on a coffee table, desk, counter or other suitable surface where user A and such other persons could gather within comfortable speaking and/or image capture range of the unit.

As will be apparent to those skilled in the art in the light of the foregoing disclosure, many alterations and modifications are possible in the practice of this invention without departing from the spirit or scope thereof. For example, instead of, or in addition to facilitating teleconferencing communications as described above between wireless module 22 and a remote computer/user over Internet-enabled IP communications link 14, 18; the invention further facilitates teleconferencing communications between two or more wireless modules each of which is within wireless communication range a single local computer 12. This provides a convenient method of “intercom” style audio/video communication between two or more individuals at separate locations within wireless communication range of local computer 12 (i.e. at different locations within a reasonably sized office or residential building). Operation is as described above in the context of Internet-enabled IP communications, except that instead of (or in addition to) transmitting audio/video signals to remote computer 16, Internet telephony application software 28 running on local computer 12 transmits the audio/video signals from wireless module 22 to one or more additional wireless modules (not shown) within wireless communication range of local computer 12. More particularly, with reference to block 68 of FIG. 3, rather than (or in addition to) encoding, compressing and packetizing signals received from wireless module 22 for IP transmission to a remote computer/user via the Internet 10; signals received from wireless module 22 are instead encoded with the unique identifier(s) of each of the other wireless modules within wireless communication range of local computer 12 and transmitted to each such module for reproduction of such audio/video signals by such other wireless modules. Accordingly, the scope of the invention is to be construed in accordance with the substance defined by the following claims.

What is claimed is:

1. A teleconferencing method, comprising:
(a) providing a local computer having an IP communications link to the Internet;
(b) running Internet telephony application software on said local computer;
(c) providing a microphone and a speaker remote from said local computer;
(d) transmitting a first signal representative of voice sounds detected by said microphone from said microphone to said local computer over a short range wireless link, for processing of said first signal by said Internet telephony application software and transmission of said first signal over said IP communications link to a remote computer by said Internet telephony application software; and,
(e) receiving from said remote computer over said IP communications link a second signal representative of remote sounds produced at said remote computer, processing said second signal by said Internet telephony application software and transmitting said processed second signal to said speaker over said short range wireless link, for reproduction of said remote sounds by said speaker.

2. A method as defined in claim 1, further comprising:
(a) providing a camera and a video display remote from said local computer;
(b) transmitting a third signal representative of images captured by said camera from said camera to said local computer over said short range wireless link, for processing of said third signal by said Internet telephony application software and transmission of said third signal over said IP communications link to said remote computer by said Internet telephony application software; and,
(c) receiving from said remote computer over said IP communications link a fourth signal representative of remote images captured at said remote computer, processing said fourth signal by said Internet telephony application software and transmitting said processed fourth signal to said video display over said short range wireless link, for reproduction of said remote images by said video display.

3. A method as defined in claim 1, further comprising:
(a) running command and control application software on said local computer;
(b) before said processing of said first signal by said Internet telephony application software, processing said first signal by said command and control application software to determine whether said first signal contains one or more voice commands; and,
(c) if said first signal contains one or more voice commands, further processing said first signal by said command and control application software to remove said one or more voice commands from said first signal and apply said one or more voice commands to control operation of said local computer.

4. A method as defined in claim 1, further comprising:
(a) before transmitting said first signal from said microphone to said local computer, encoding said first signal with a first identifier representative of a communication from said microphone to said local computer; and,
(b) before transmitting said processed second signal to said speaker over said short range wireless link, encoding said second signal with a second identifier representative of a communication from said local computer to said speaker.

5. A method as defined in claim 4, further comprising:
(a) before said processing of said first signal by said Internet telephony application software, decoding said first identifier from said first signal to distinguish said first signal from signals other than said first signal;
(b) after said processing of said first signal by said Internet telephony application software, encoding said first signal with a third identifier representative of a communication from said microphone to said remote computer; and,
(c) before said processing of said second signal by said Internet telephony application software, decoding said second identifier from said second signal to distinguish said second signal from signals other than said second signal.

6. A method as defined in claim 3, further comprising:
(a) before transmitting said first signal from said microphone to said local computer, encoding said first signal with a first identifier representative of said local computer; and,
(b) before transmitting said processed second signal to said speaker over said short range wireless link, encoding said second signal with a second identifier representative of said speaker.

7. A method as defined in claim 6, further comprising:
(a) before said processing of said first signal by said Internet telephony application software, decoding said first identifier from said first signal to distinguish said first signal from signals other than said first signal;
(b) after said processing of said first signal by said Internet telephony application software, encoding said first signal with a third identifier representative of said remote computer; and,
(c) before said processing of said second signal by said Internet telephony application software, decoding said second identifier from said second signal to distinguish said second signal from signals other than said second signal.

8. Internet telephony communication apparatus comprising:
(a) a microphone;
(b) a speaker;
(c) a first antenna;
(d) a first receiver/transmitter electrically coupled between said microphone, said speaker and said first antenna;
(e) a power supply electrically coupled between said microphone, said speaker, said first antenna and said first receiver/transmitter;
(f) a second antenna and a second receiver/transmitter electrically connectible to a local computer running Internet telephony application software;
wherein:
(i) a first signal representative of voice sounds detected by said microphone is transmitted by said first receiver/transmitter and said first antenna to said second antenna and said second receiver/transmitter over a short range wireless link, for processing of said first signal by said Internet telephony application software and transmission of said first signal over an IP communications link to a remote computer by said Internet telephony application software; and,
(ii) a second signal representative of remote sounds produced at said remote computer is received over said IP communications link, processed by said Internet telephony application software and transmitted by said second receiver/transmitter and said second antenna to said first antenna and said first receiver/transmitter over said short range wireless link for reproduction of said remote sounds by said speaker.

9. Apparatus as defined in claim 8, further comprising:
(a) a camera electrically coupled to said first receiver/transmitter and to said power supply;
(b) a video display electrically coupled to said first receiver/transmitter and to said power supply;
wherein:
(i) a third signal representative of images captured by said camera is transmitted by said first receiver/transmitter and said first antenna to said second antenna and said second receiver/transmitter over said short range wireless link, for processing of said third signal by said Internet telephony application software and transmission of said third signal over said IP communications link to said remote computer by said Internet telephony application software; and,
(ii) a fourth signal representative of remote images captured at said remote computer is received over said IP communications link, processed by said Internet telephony application software and transmitted by said second receiver/transmitter and said second antenna to said first antenna and said first receiver/transmitter over said short range wireless link for reproduction of said remote images by said video display.

10. Apparatus as defined in claim 8, further comprising:
(a) a first identifier encoder/decoder electrically coupled to said first receiver/transmitter to encode said first signal with a first identifier representative of said second receiver/transmitter and to decode from said second signal a second identifier representative of said first receiver/transmitter; and,
(b) a second identifier encoder/decoder electrically coupled to said second receiver/transmitter to encode said second signal with said second identifier and to decode said first identifier from said first signal.

11. Apparatus as defined in claim 8, wherein said microphone, said speaker, said first antenna, said first receiver/transmitter, said first identifier encoder/decoder and said power supply are provided in a portable unit movable with respect to said local computer throughout a region corresponding to a communication range for signals transmitted or received via said short range wireless link.

12. Apparatus as defined in claim 9, wherein said microphone, said speaker, said first antenna, said first receiver/transmitter, said first identifier encoder/decoder, said power supply, said camera and said video display are provided in a portable unit movable with respect to said local computer throughout a region corresponding to a communication range for signals transmitted or received via said short range wireless link.

13. Apparatus as defined in claim 8, wherein said speaker, said first antenna, said first receiver/transmitter, said first identifier encoder/decoder and said power supply are provided in a portable unit movable with respect to said local computer throughout a region corresponding to a communication range for signals transmitted or received via said short range wireless link; and, wherein said microphone is a lavalier microphone electrically connected to and movable with said portable unit.

14. Apparatus as defined in claim 9, wherein said microphone, said speaker, said first antenna, said first receiver/transmitter, said first identifier encoder/decoder, said camera and said power supply are provided in a portable unit movable with respect to said local computer throughout a region corresponding to a communication range for signals transmitted or received via said short range wireless link; and, wherein said video display is electrically connected to and movable with said portable unit.

15. A teleconferencing method, comprising:
(a) providing a local computer;
(b) running Internet telephony application software on said local computer;
(c) providing a first microphone and a first speaker at a first location remote from and within wireless communication range of said local computer;
(d) providing a second microphone and a second speaker at a second location remote from said first location and remote from and within wireless communication range of said local computer;
(e) transmitting a first signal representative of voice sounds detected by said first microphone from said first microphone to said local computer over a first short range wireless link;
(f) processing said first signal by said Internet telephony application software and transmitting said first signal from said local computer to said second speaker over a second short range wireless link;
(g) transmitting a second signal representative of voice sounds detected by said second microphone from said second microphone to said local computer over said second short range wireless link; and,
(h) processing said second signal by said Internet telephony application software and transmitting said second signal from said local computer to said first speaker over said first short range wireless link.

16. A method as defined in claim 15, further comprising:
(a) providing a first camera and a first video display at said first location;
(b) providing a second camera and a second video display at said second location;
(c) transmitting a third signal representative of images captured by said first camera from said first camera to said local computer over said first short range wireless link;
(d) processing said third signal by said Internet telephony application software and transmitting said third signal from said local computer to said second video display over said second short range wireless link;
(e) transmitting a fourth signal representative of images captured by said second camera from said second camera to said local computer over said second short range wireless link; and,
(f) processing said fourth signal by said Internet telephony application software and transmitting said fourth signal from said local computer to said first video display over said first short range wireless link.

17. Teleconferencing apparatus comprising:
(a) a local computer running Internet telephony application software;
(b) a first microphone, a first speaker, a first antenna and a first receiver/transmitter at a first location remote from and within wireless communication range of said local computer;
(c) a second microphone, a second speaker, a second antenna and a second receiver/transmitter at a second location remote from said first location and remote from and within wireless communication range of said local computer;
(d) a third antenna and a third receiver/transmitter electrically coupled to said local computer;
wherein:
(i) a first signal representative of sounds detected by said first microphone is transmitted by said first receiver/transmitter and said first antenna to said third antenna and said third receiver/transmitter over a first short range wireless link, processed by said Internet telephony application software, further transmitted from said third receiver/transmitter and said third antenna to said second antenna and said second receiver/transmitter over a second short range wireless link for reproduction on said second speaker of said sounds detected by said first microphone; and,
(ii) a second signal representative of sounds detected by said second microphone is transmitted by said second receiver/transmitter and said second antenna to said third antenna and said third receiver/transmitter over said second short range wireless link, processed by said Internet telephony application software, further transmitted from said third receiver/transmitter and said third antenna to said first antenna and said first receiver/transmitter over said first short range wireless link for reproduction on said first speaker of said sounds detected by said second microphone.

18. Teleconferencing apparatus as defined in claim 17, further comprising:
(a) a first camera electrically coupled to said first receiver/transmitter;
(b) a first video display electrically coupled to said first receiver/transmitter;
(c) a second camera electrically coupled to said second receiver/transmitter;
(d) a second video display electrically coupled to said second receiver/transmitter;
wherein:
(i) a third signal representative of images captured by said first camera is transmitted by said first receiver/transmitter and said first antenna to said third antenna and said third receiver/transmitter over said first short range wireless link, processed by said Internet telephony application software, further transmitted from said third receiver/transmitter and said third antenna to said second antenna and said second receiver/transmitter over said second short range wireless link for reproduction on said second video display of said images captured by said first camera; and,
(ii) a fourth signal representative of images captured by said second camera is transmitted by said second receiver/transmitter and said second antenna to said third antenna and said third receiver/transmitter over said second short range wireless link, processed by said Internet telephony application software, further transmitted from said third receiver/transmitter and said third antenna to said first antenna and said first receiver/transmitter over said first short range wireless link for reproduction on said first video display of said images captured by said second camera.
